(19) United States
(12) Patent Application Publication
(10) Pub. No.: US 2005/0281409 A1
(43) Pub. Date: Dec. 22, 2005

(54) Multi-channel audio system

(76) Inventors: Sachirou Sakane, Tochigi (JP); Ryuichi Sawada, Kanagawa (JP)

Correspondence Address: DICKSTEIN SHAPIRO MORIN & OSHINSKY LLP, 2101 L Street, NW, Washington, DC, 20037, US

(21) Appl. No.: 11/072,333

(22) Filed: Mar. 7, 2005

(30) Foreign Application Priority Data
Jun. 18, 2004 (JP) 2004-180591

(51) Int. Cl. H04R 5/00; H04R 5/02

(52) U.S. Cl. 381/18; 381/307

(57) ABSTRACT

The invention provides a multi-channel audio system which creates a multi-channel surround environment by outputting a front signal, a surround signal and a surround back signal. The system has surround speakers each including a surround speaker unit for outputting sound corresponding to the surround signal and a surround back speaker unit for outputting sound corresponding to the surround back signal in a direction different from the sound outputting direction of the surround speaker.

### BACKGROUND OF THE INVENTION

This invention relates to an improvement to a multi-channel audio system which reproduces sound in multiple channels.

A multi-channel audio system uses a plurality of speakers corresponding to the number of its channels. For example, a center speaker, front L and R speakers and surround L and R speakers are arranged on the same circumference with the position of a listener as the center in a multi-channel surround audio system. The center speaker is arranged in front of the listener. When the position of the front speaker is 0°, the front L/R speakers are respectively arranged at positions of 30° on the right and left sides of the front speaker and the surround L/R speakers are respectively arranged at positions of 100° to 120°. Such an arrangement of the speakers of the multi-channel audio system is recommended in ITU-R Recommendation. The term “ITU-R Recommendation” means Recommendation “BS775-1” by International Telecommunications Union (ITU). Japanese domestic re-publication of PCT international application No. 2001-501784 (page 1, FIG. 1), for example, discloses the speaker arrangement for such multi-channel surround reproduction.

### SUMMARY OF THE INVENTION

A 5.1-channel system includes a sub-woofer in addition to the center speaker, the front L/R speakers and the surround L/R speakers. An audio system capable of 6.1-channel or 7.1-channel multi-channel surround reproduction has become available in recent years by adding one or two surround back speakers positioned at the back of the listener to this 5.1-channel system.

In the 6.1-channel or 7.1-channel multi-channel audio system, however, a space for installing the surround back speaker or speakers cannot be sufficiently secured in some cases at the back of the listener.

In such a case, the audio system can substantially execute only 5.1-channel surround reproduction (sound output) although an output apparatus such as an amplifier has a sound output capacity of the 6.1 channels or 7.1 channels.

In view of the circumstances described above, the invention is useful for a technology that makes it possible to make multi-channel surround reproduction of 6 or more channels without arranging a surround back speaker or speakers at the back of a listener inside a limited space in a multi-channel audio system.

According to one aspect of the invention, there is provided a multi-channel audio system which creates a multi-channel surround environment by outputting a front signal, a surround signal and a surround back signal, including surround speakers, wherein each of the surround speakers in turn includes a surround speaker unit which outputs sound corresponding to the surround signal and a surround back speaker unit which outputs sound corresponding to the surround back signal in a direction different from the sound outputting direction of the surround speaker.

### BRIEF DESCRIPTION OF THE DRAWINGS

The invention will now be described by way of examples with reference to the accompanying drawing, throughout which like parts are referred to by like references, and in which:

FIG. 1 is an explanatory view useful for explaining an example where a multi-channel audio system according to an embodiment of the invention is used in a certain room;

FIG. 2 is a perspective view of a speaker according to the embodiment of the invention; and

FIG. 3 is a perspective view of a speaker according to the embodiment of the invention.

### DETAILED DESCRIPTION OF THE INVENTION

A multi-channel audio system according to an embodiment will be hereinafter explained with reference to the drawings.

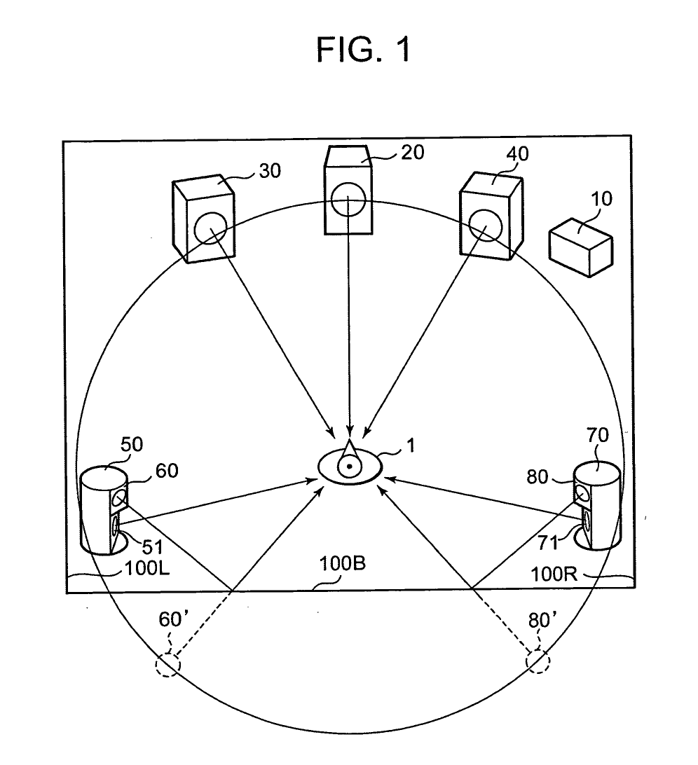

FIG. 1 is an explanatory view showing an example where a multi-channel audio system according to an embodiment of the invention is installed in a certain room. The multi-channel audio system shown in FIG. 1 includes a center speaker 20, front L/R speakers 30 and 40 and surround L/R speaker 50 and 70 and is connected by wire/wireless connection to an audio signal output apparatus 10. A sub-woofer, not shown in FIG. 1, is arranged at an arbitrary position but need not always be disposed.

The multi-channel audio system according to this embodiment creates a surround environment of at least 6 channels such as 6 channels, 6.1 channels, 7 channels and 7.1 channels by the group of five speakers described above as will be later explained in detail. Incidentally, the 0.1 channel means a sub-woofer.

In the example shown in FIG. 1, the center speaker 20, the front L/R speakers 30 and 40 and the surround L/R speakers 50 and 70 are arranged substantially on the same circumference with a listening point (the position of a listener 1) as the center preferably in accordance with ITU (International Telecommunications Union)—R Recommendation BS775-1.

In the embodiment, the room in which the system of the embodiment is installed is relatively small and the circle having the radius necessary for providing the pleasant surround audio environment to the listener 1 inside the room is not contained inside the room.

The audio signal output apparatus 10 is a player, an amplifier, or the like, capable of outputting multi-channel surround sound of multi-channels, particularly 6 or more channels. The audio signal output apparatus 10 may well be arranged outside the room.

The center speaker 20 is arranged just in front of the listener 1. The center speaker 20 receives the sound (center sound) corresponding to the center signal from the audio signal output apparatus 10 and outputs the sound.

The front L/R speakers 30 and 40 are respectively arranged on the right and left sides in front of the listener 1. The front L/R speakers 30 and 40 receive the sound (front L/R sound) corresponding to front L/R signals from the audio signal output apparatus 10 and output the respective sound. The front L/R speakers 30 and 40 are preferably arranged at positions at 30° on the right and left sides respectively with the position of the center speaker 20 as 0° in accordance with the Recommendation described above.

The surround L/R speakers 50 and 70 are respectively arranged on the right and left sides of the listener 1. The surround L/R speakers 50 and 70 receive the sound (surround L/R sound) corresponding to surround L/R signals and the sound (surround back L/R sound) corresponding to surround back L/R signals from the audio signal output apparatus 10 and output the respective sound. The surround L/R speakers 50 and 70 are preferably arranged at positions of 100° to 120° on the right and left side respectively with the position of the center speaker 20 as 0° in accordance with the Recommendation described above. The room in this embodiment is relatively small but has a space in which at least the surround L/R speakers 50 and 70 can be arranged at the back of the listener 1 in the arrangement described above.

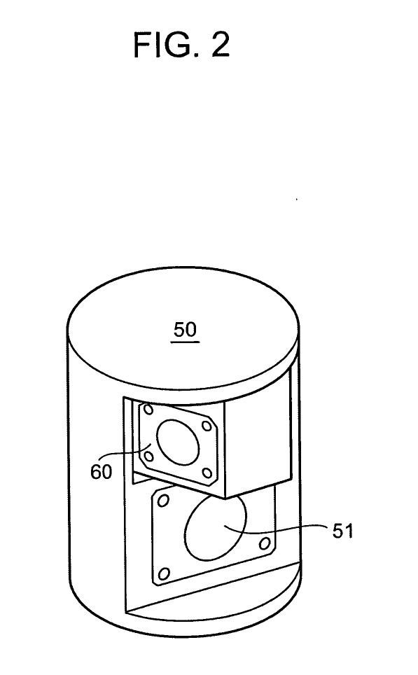

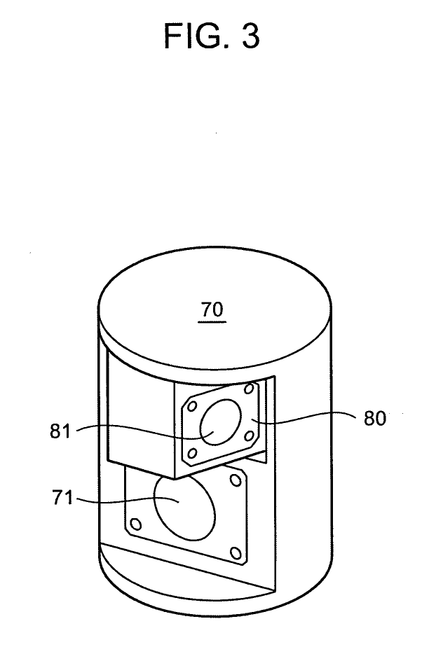

FIG. 2 and FIG. 3 are perspective views of the surround L/R speakers 50 and 70 according to the embodiment. The surround L speaker 50 shown in FIG. 2 includes a surround L speaker unit 51 and a surround back L speaker unit 60. Similarly, the surround R speaker 70 shown in FIG. 3 includes a surround R speaker unit 71 and a surround back R speaker unit 80.

The surround L/R speaker units 51 and 71 of the surround L/R speakers 50 and 70 output the respective surround L/R sound preferably from an angle of 100° to 120° on both right and left sides of the listener 1.

The surround back L/R speaker units 60 and 80 output the respective surround back L/R sound in different directions from the output directions (sound radiation directions) of the surround L/R speaker units 51 and 71. The surround back L/R speaker units 60 and 80 preferably output the surround back L/R sound to the wall of the room at the back of the listener 1 in such a fashion that the reflecting sound reaches the listener 1.

The surround L/R speakers 50 and 70 respectively have at the back thereof signal input terminals (not shown in the drawing) for the surround L/R speaker units 51 and 71 and for the surround back L/R speaker units 60 and 80, for example, and the surround sound signals and the surround back sound signals are respectively inputted to these signal input terminals. Needless to say, a signal reception portion is disposed in place of the signal input terminals in the case of wireless signal input.

The sound outputted from the surround L/R speaker units 51 and 71 and from the surround back L/R speaker units 60 and 80 constitutes the surround sound of the multiple channels. In other words, the surround back L/R sound outputted from the surround back L/R speaker units 60 and 80 and reflected from the wall 100B at the back of the listener 1 reaches the listener 1 as shown in FIG. 1. The listener 1 feels this reflecting sound as the surround back sound outputted from virtual positions 60′ and 80′. The virtual positions 60′ and 80′ exist outside the room. The surround back L/R speaker units 60 and 80 preferably output the sound towards the point of intersection between a line connecting each virtual position 60′ and 80′ to the ideal listening point (the position of the listener 1) and the wall surface 100B.

The surround back sound so reflected creates the surround environment of 7 channels (or 7.1 channels with the sub-woofer) at the position of the listener 1 in cooperation with the front sound from the center speaker 20 and the front R/L speakers 30 and 40. When the same sound is outputted as the surround back R/L sound, the surround environment of 6 or 6.1 channels is created.

In the multi-channel audio system according to the embodiment explained above, the surround back sound is outputted from the positions of the surround speakers in the different direction from the surround signals even when a sufficient installation space of the surround back speakers cannot be secured. Therefore, multi-channel surround reproduction can be made with the sound output corresponding to the surround back signals.

In other words, the multi-channel audio system according to this embodiment can create the audio surround environment of 6 or more channels even when the installation positions of the surround back L/R speakers 60 and 80 cannot be secured sufficiently due to the limitation of the listening room.

In other words, this embodiment can substantially provide multi-channel surround reproduction of 6 or more channels to the listener 1 by using the surround back speakers although the speaker arrangement is the arrangement of 5- or 5.1-channel surround speakers apparently using 5 speakers.

The multi-channel audio system according to the embodiment can reproduce the multi-channel sound signals of 6 or more channels from the audio signal output apparatus 10 without the necessity for processing such as down-mixing for the reproduction of 5 or 5.1 channels. Therefore, it is not necessary to provide a dedicated DSP (Digital Signal Processor) to the sound output apparatus 10 and to execute a dedicated processing.

Additionally, the inventors of the invention have conducted experiments by reproducing the sound of the standard 6.1 channels and 7.1 channels by using the system according to the embodiment. It has eventually been confirmed that the reproduction is by no means inferior to the reproduction by using standard setting of 6.1 or 7.1 channels practically using the surround back speaker and the surround back sound can be heard from just behind although the surround back sound sounds somewhat expanding transversely.

In the embodiment described above, the surround back L/R sound from the surround back L/R speakers 60 and 80 may be reflected by the wall surfaces 100L/R on the left and right sides and the wall surface 100B at the back and may be allowed to reach the position of the listener 1.

In the embodiment described above, the sound outputting direction of the speakers may be made different by providing an acoustic reflecting member or an acoustic lens to at least one of the surround speaker L/R units 51 and 71 or at least one of the surround back L/R speakers 60 and 80. According to this arrangement, it becomes possible to set up the surround speaker L/R units 51 and 71 or the surround back L/R speaker units 60 and 80 in the same direction (angle) and to set the sound outputting direction to the direction shown in FIG. 1 by the acoustic reflecting member or the acoustic lens.

The surround L/R speaker units 51 and 71 and the surround back L/R speaker units 60 and 80 are preferably constituted in such a fashion that their sound outputting directions are variable. In this case, each unit is fixed to the speaker by a rotary shaft, for example, and the output surface is movable in the horizontal direction with the rotary shaft being the center. When the outputting direction of each unit is variable, the reflecting angle of the surround back L/R sound can be appropriately set in accordance with the distance to the wall surface 100B of the room on the basis of the arrangement positions of the surround L/R speakers 50 and 70.

To adjust the direction of each unit, an adjustment mechanism for adjusting the angle (mutual direction), using a motor or the like, may be disposed inside the speaker. In this case, the listener 1 can change the direction on the basis of a control signal from the audio signal output apparatus 10 or a remote transmitter not shown in the drawing.

Furthermore, a construction in which the reflecting direction or refracting direction of the acoustic reflecting member or acoustic lens provided to at least one of the units is changeable may be employed. This construction enables the listener 1 to adjust the conditions of the surround sound and the surround back sound at the listening position. In this case, it is further preferred to conduct the adjustment by reproducing a test tone containing the surround back sound.

When the outputting direction of the surround back sound is adjusted by the means described above, the surround back sound reflected by the wall surface under the appropriate condition reaches the listening position from the back of the listener 1. Consequently, the multi-channel surround environment involving the surround back sound can be created at the position of the listener 1.

In the embodiment described above, FIG. 2 and FIG. 3 show the surround speaker units 51 and 71 and the surround back speaker units 60 and 80 that are stacked vertically with one another. However, these units 51 and 71 and 60 and 80 maybe aligned in the horizontal direction. Further, an enclosure of each speaker may have any shape such as a polyhedron including a cube, a rectangle, a cylinder, a circular cone, a sphere and so forth. The enclosure is preferably selected in an appropriate way on the basis of the speaker unit, reflection of the output sound, and so forth.

The embodiment explained above deals with the formation of the multi-channel surround environment of 6, 6.1, 7 and 7.1 channels but the invention is not limited thereto. For example, the invention can be applied to a multi-channel surround audio system of 8 or more channels such as 8 channels and 9 channels requiring 3 or more back speakers. In this case, each of the surround speakers 50 and 70 has two surround back speaker units and the sound is outputted from the three units in mutually different directions to create the surround environment of 8 or more channels.

Although only some exemplary embodiments of the invention have been described in detail above, those skilled in the art will readily appreciate that many modifications are possible in the exemplary embodiments without materially departing from the novel teachings and advantages of the present invention. Accordingly, all such modifications are intended to be included within the scope of the present invention.

The disclosure of Japanese Patent Application No. 2004-180591 filed on Jun. 18, 2004, including specification, claims, drawings and abstract is incorporated herein by reference in its entirety.

1. A multi-channel audio system which creates a multi-channel surround environment by outputting a front signal, a surround signal and a surround back signal, comprising surround speakers each including:
a surround speaker unit which outputs sound corresponding to the surround signal; and
a surround back speaker unit which outputs sound corresponding to the surround back signal in a direction different from a sound outputting direction of said surround speaker.

2. The multi-channel audio system according to claim 1, wherein the surround back speaker unit is arranged in the surround speaker in such a fashion that the sound outputting direction of the surround back speaker unit is changeable.

3. The multi-channel audio system according to claim 1, wherein the surround back speaker unit outputs sound corresponding to the surround back signal to a wall and creates a multi-channel surround environment by using a reflected sound from the wall.

4. The multi-channel audio system according to claim 3, wherein the surround back speaker unit is arranged in the surround speaker in such a fashion that the sound outputting direction of the surround back speaker unit is changeable.

5. A surround speaker included in a multi-channel audio system which creates a multi-channel surround environment by outputting a front signal, a surround signal and a surround back signal, said speaker comprising:
a surround speaker unit which outputs sound corresponding to the surround signal; and
a surround back speaker unit which outputs sound corresponding to the surround back signal in a direction different from a sound outputting direction of said surround speaker.

6. The speaker according to claim 5, wherein the surround back speaker unit is arranged in the surround speaker in such a fashion that the sound outputting direction of the surround back speaker unit is changeable.

7. The speaker according to claim 5, wherein the surround back speaker unit outputs sound corresponding to the surround back signal to a wall and creates a multi-channel surround environment by using the reflected sound from the wall.

8. The speaker according to claim 7, wherein the surround back speaker unit is arranged in the surround speaker in such a fashion that the sound outputting direction of the surround back speaker unit is changeable.

9. A method of outputting a multi-channel audio signal which creates a multi-channel surround environment by outputting a front signal, a surround signal and a surround back signal, the method comprising:
outputting sound corresponding to the surround back signal to a wall from an output position of the surround signal outputting sound corresponding to the surround signal to create a multi-channel surround environment by using reflected sound from the wall.
